(19) United States
(12) Patent Application Publication
(10) Pub. No.: US 2013/0177706 A1
(43) Pub. Date: Jul. 11, 2013

(54) METHOD FOR SEASONING UV CHAMBER OPTICAL COMPONENTS TO AVOID DEGRADATION

(71) Applicants: Sanjeev Baluja, Campbell, CA (US); Alexandros T. Demos, Fremont, CA (US); Bo Xie, Santa Clara, CA (US); Juan Carlos Rocha-Alvarez, San Carlos, CA (US)

(72) Inventors: Sanjeev Baluja, Campbell, CA (US); Alexandros T. Demos, Fremont, CA (US); Bo Xie, Santa Clara, CA (US); Juan Carlos Rocha-Alvarez, San Carlos, CA (US)

(21) Appl. No.: 13/719,047

(22) Filed: Dec. 18, 2012

Related U.S. Application Data
(60) Provisional application No. 61/584,658, filed on Jan. 9, 2012.

(51) Int. Cl. B05D 3/06

(52) U.S. Cl. CPC B05D 3/066
USPC 427/226

(57) ABSTRACT

Methods for depositing a carbon-based seasoning layer on exposed surfaces of the optical components within a UV processing chamber are disclosed. In one embodiment, the method includes flowing a carbon-containing precursor radially inwardly across exposed surfaces of optical components within the thermal processing chamber from a circumference of the optical components, exposing the carbon-containing precursor to a thermal radiation emitted from a heating source to form a carbon-based seasoning layer on the exposed surfaces of the optical components, exposing the carbon-based seasoning layer to ozone, wherein the ozone is introduced into the processing chamber by flowing the ozone radially inwardly across exposed surfaces of optical components from the circumference of the optical components, heating the optical components to a temperature of about 400° C. or above while flowing the ozone to remove the carbon-based seasoning layer from exposed surfaces of the optical components.

### CROSS-REFERENCE TO RELATED APPLICATIONS

This application claims benefit of U.S. provisional patent application Ser. No. 61/584,658, filed Jan. 9, 2012, which is herein incorporated by reference.

### BACKGROUND OF THE INVENTION

1. Field of the Invention

Embodiments of the invention relate to processing tools for forming and processing films on substrates with UV energy. In particular, embodiments of the invention relate to seasoning optical components within a processing chamber.

2. Description of the Related Art

Materials with low dielectric constants (low-k), such as silicon oxides (SiOₓ), silicon carbide (SiCₓ), and carbon doped silicon oxides (SiOCₓ), find extremely widespread use in the fabrication of semiconductor devices. Using low-k materials as the inter-metal and/or inter-layer dielectric between conductive interconnects reduces the delay in signal propagation due to capacitive effects. The lower the dielectric constant of the dielectric layer, the lower the capacitance of the dielectric and the lower the RC delay of the integrated circuit (IC).

Current efforts are focused on improving low-k dielectric materials, often referred to as ultra low-k (ULK) dielectrics, with k values less than 2.5 for the most advanced technology needs. Ultra low-k dielectric materials may be obtained by, for example, incorporating air voids within a low-k dielectric matrix, creating a porous dielectric material. Methods of fabricating porous dielectrics typically involve forming a “precursor film” containing two components: a porogen (typically an organic material such as a hydrocarbon) and a structure former or dielectric material (e.g., a silicon containing material). Once the precursor film is formed on the substrate, the porogen component can be removed, leaving a structurally intact porous dielectric matrix or oxide network.

Techniques for removing porogens from the precursor film include, for example, a thermal process in which the substrate is heated to a temperature sufficient for the breakdown and vaporization of the organic porogen. One known thermal process for removing porogens from the precursor film includes a UV curing process to aid in the post treatment of CVD silicon oxide films. However, various exposed surfaces of the optical components, such as the quartz based vacuum window or showerhead, disposed in the UV processing chamber can become coated with silicon-based (from a structure former or dielectric precursor) and/or organic-based (from a porogen precursor) residues, which results in a continual degradation of the UV source efficiency or particle contamination of the substrate during subsequent processing. The build-up of these residues on the surfaces requires periodic cleaning, which results in significant tool downtime and a corresponding reduction in throughput. In addition, it has been observed that silicon-based residues cannot be easily removed with a conventional chamber plasma-cleaning process using an oxygen-based gas. While a fluorine-based cleaning gas may be effective for removing silicon-based residues, the fluorine-based cleaning gas tends to etch surfaces of the optical components as a result of fluorine radical attack.

Common solutions for the use of fluorine-based cleaning gas in removing silicon-based residues/build-up involve using a fluorine etch resistant coating on the optical components. However, fluorine etch resistant coatings may eventually fail or flake off, causing the device performance to suffer or unnecessary part replacement. Other solutions involve using etch resistant materials with high UV transmission such as sapphire. However, the costs can be 20 to 30 times higher.

Therefore, a need exists to increase UV efficiency and minimize build-up of porogen or residues on the surfaces of the optical components within a UV processing chamber.

### SUMMARY OF THE INVENTION

Embodiments of the invention generally provide methods for application of a carbon-based seasoning layer on optical components, such as an UV vacuum window or showerhead, within a UV processing chamber. In one embodiment, a method for treating a thermal processing chamber is provided. The method generally includes flowing a carbon-containing precursor into the thermal processing chamber, comprising introducing the carbon-containing precursor into an upper processing region of the thermal processing chamber, the upper processing region located between a window and a transparent showerhead positioned within the thermal processing chamber, and flowing the carbon-containing precursor through one or more passages formed in the transparent showerhead and into a lower processing region, the lower processing region located between the transparent showerhead and a substrate support located within the thermal processing chamber, exposing the carbon-containing precursor to a thermal radiation to form a carbon-based seasoning layer on exposed surfaces of the window and the transparent showerhead within the thermal processing chamber, and exposing the carbon-based seasoning layer to ozone to remove the carbon-based seasoning layer from exposed surfaces of the window and the transparent showerhead.

In another embodiment, a method for treating a thermal processing chamber is provided. The method generally includes providing a dummy substrate into the thermal processing chamber, the dummy substrate having a carbon-containing layer formed thereon, exposing the carbon-containing layer to a thermal radiation to outgass carbon-based species which form a desired thickness of a carbon-based seasoning layer on exposed surfaces of exposed surfaces of optical components within the thermal processing chamber, removing the dummy substrate, and exposing the carbon-based seasoning layer to ozone to remove the carbon-based seasoning layer from exposed surfaces of the optical components.

In yet another embodiment, the method for treating a thermal processing chamber is provided. The method generally includes flowing a carbon-containing precursor radially inwardly across exposed surfaces of one or more optical components within the thermal processing chamber from a circumference of the one or more optical components, exposing the carbon-containing precursor to a thermal radiation emitted from a heating source to form a carbon-based seasoning layer on the exposed surfaces of the one or more optical components, exposing the carbon-based seasoning layer to ozone, wherein the ozone is introduced into the processing chamber by flowing the ozone radially inwardly across exposed surfaces of one or more optical components from the circumference of the one or more optical components, heating the one or more optical components to a temperature of about 400° C. or above while flowing the ozone to remove the carbon-based seasoning layer from exposed surfaces of the one or more optical components.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a partial cross-sectional section view of a tandem processing chamber that has a lid assembly with two UV bulbs disposed respectively above two processing regions.

FIG. 2 is a schematic isometric cross-sectional view of a portion of one of the processing chambers without the lid assembly.

FIG. 3 is a schematic cross-sectional view of the processing chamber in FIG. 2 illustrating a gas flow path.

FIG. 4 is an exemplary process sequence for pre-treating exposed surfaces of optical components within a UV processing chamber in accordance with one embodiment of the present invention.

FIG. 5 is a close up isometric cross-sectional view of a portion of the processing chamber and a gas flow path as shown in FIG. 3.

FIG. 6 is an exemplary process sequence for pre-treating exposed surfaces of optical components within a UV processing chamber in accordance with another embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention generally provide methods for depositing a carbon-based seasoning layer on exposed surfaces of the optical components (such as an UV vacuum window or showerhead) within a UV processing chamber. The application of the carbon-based seasoning layer protects the optical components from fluorine radical attack during the cleaning while preventing any residue build-up on the optical components in the subsequent processing of the substrate. Additionally, the chamber walls, optical components, and substrate support may be efficiently cleaned with a simple ozone cleaning process with an optimized flow profile distribution across a substrate being processed within the UV processing chamber, a lamp heated chamber, or other chambers where energy in the form of light is used to process a film or catalyze a reaction, either directly on or above the substrate. By preventing any residue build-up on the optical components, chamber components may need to be cleaned or replaced less frequently, thereby reducing the cost associated with reactor maintenance. Although any processing chamber or process may use embodiments of the invention, UV curing of porogen-containing films will be used below to describe the invention.

### Exemplary Hardware

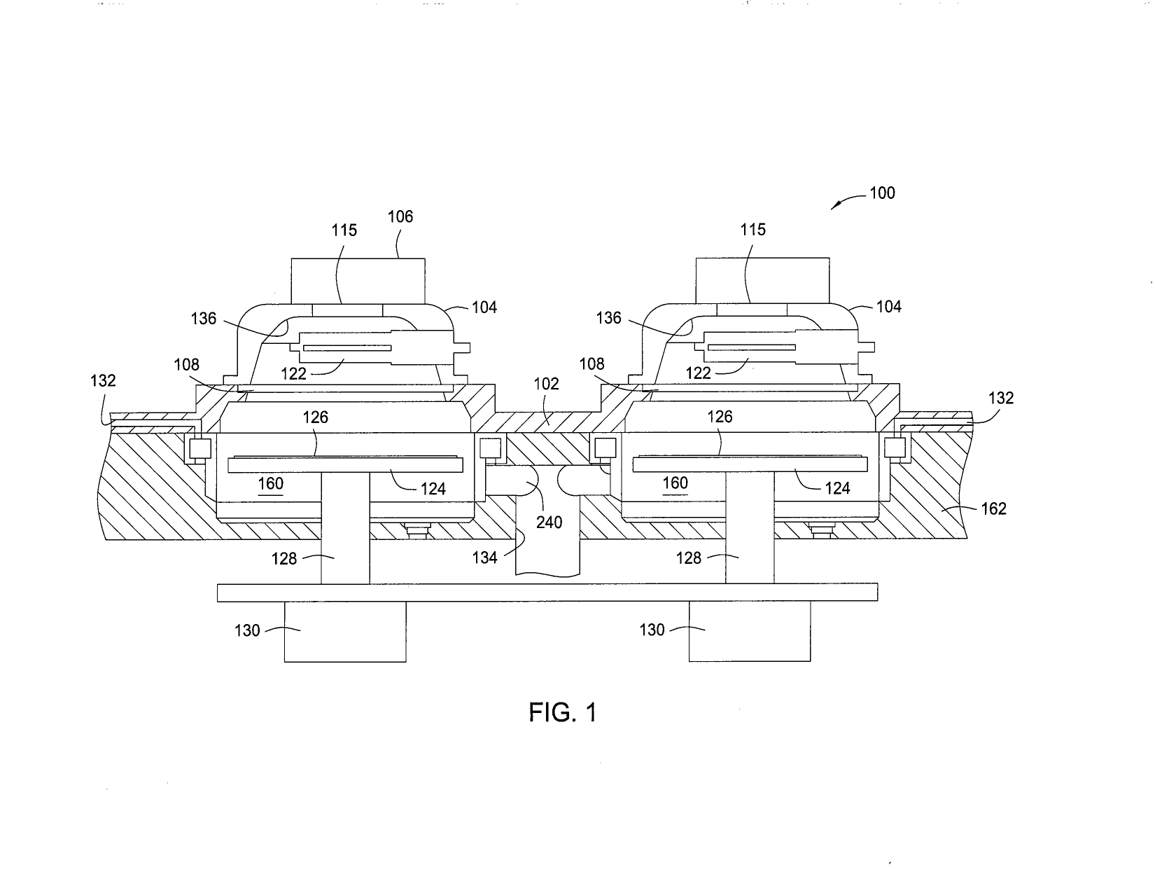

FIG. 1 illustrates a cross-sectional view of an exemplary tandem processing chamber 100, which provides two separate and adjacent processing regions in a chamber body for processing the substrates. The processing chamber 100 has a lid 102, housings 104 and power sources 106. Each of the housings 104 cover a respective one of two UV lamp bulbs 122 disposed respectively above two processing regions 160 defined within the body 162. Each of the processing regions 160 includes a heating substrate support, such as substrate support 124, for supporting a substrate 126 within the processing regions 160. The UV lamp bulbs 122 emit UV light that is directed through the windows onto each substrate located within each processing region. The substrate supports 124 can be made from ceramic or metal such as aluminum. The substrate supports 124 may couple to stems 128 that extend through a bottom of the body 162 and are operated by drive systems 130 to move the substrate supports 124 in the processing regions 160 toward and away from the UV lamp bulbs 122. The drive systems 130 can also rotate and/or translate the substrate supports 124 during curing to further enhance uniformity of substrate illumination. The exemplary tandem processing chamber 100 may be incorporated into a processing system, such as a Producer™ processing system, commercially available from Applied Materials, Inc., of Santa Clara, Calif.

The UV lamp bulbs 122 can be an array of light emitting diodes or bulbs utilizing any of the state of the art UV illumination sources including, but not limited to, microwave arcs, radio frequency filament (capacitively coupled plasma) and inductively coupled plasma (ICP) lamps. The UV light can be pulsed during a cure process. Various concepts for enhancing uniformity of substrate illumination include use of lamp arrays which can also be used to vary wavelength distribution of incident light, relative motion of the substrate and lamp head including rotation and periodic translation (sweeping), and real-time modification of lamp reflector shape and/or position. The UV bulbs are a source of ultraviolet radiation, and may transmit a broad spectral range of wavelengths of UV and infrared (IR) radiation.

The UV lamp bulbs 122 may emit light across a broad band of wavelengths from 170 nm to 400 nm. The gases selected for use within the UV lamp bulbs 122 can determine the wavelengths emitted. UV light emitted from the UV lamp bulbs 122 enters the processing regions 160 by passing through windows 108 disposed in apertures in the lid 102. The windows 108 may be made of an OH free synthetic quartz glass and have sufficient thickness to maintain vacuum without cracking. The windows 108 may be fused silica that transmits UV light down to approximately 150 nm. Since the lid 102 seals to the body 162 and the windows 108 are sealed to the lid 102, the processing regions 160 provide volumes capable of maintaining pressures from approximately 1 Torr to approximately 650 Torr. Processing or cleaning gases may enter the processing regions 160 via a respective one of two inlet passages 132. The processing or cleaning gases then exit the processing regions 160 via a common outlet port 134.

Each of the housings 104 includes an aperture 115 adjacent the power sources 106. The housings 104 may include an interior parabolic surface defined by a cast quartz lining 136 coated with a dichroic film. The dichroic film usually constitutes a periodic multilayer film composed of diverse dielectric materials having alternating high and low refractive index. Therefore, the quartz linings 136 may transmit infrared light and reflect UV light emitted from the UV lamp bulbs 122. The quartz linings 136 may adjust to better suit each process or task by moving and changing the shape of the interior parabolic surface.

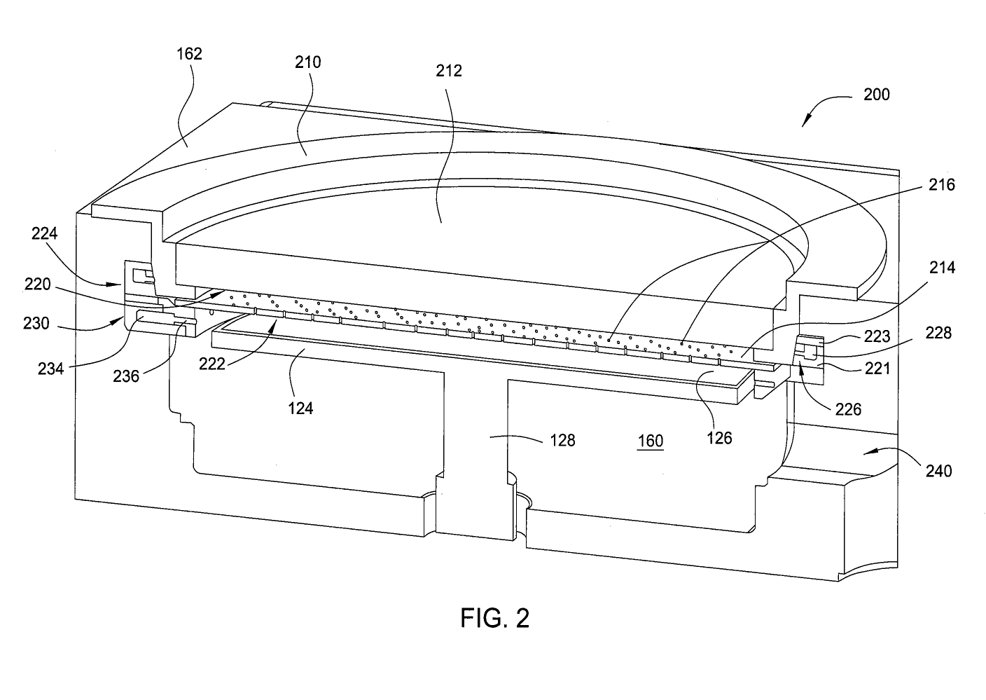

FIG. 2 shows a schematic isometric cross-sectional view of a portion of one of the processing chambers 200, which may be used in place of any of the processing region of the tandem processing chamber 100. The design of hardware shown in FIG. 2 enables a specific gas flow profile distribution across the substrate 126 being processed in a UV chamber, lamp heated chamber, or other chamber where light energy is used to process a film or catalyze a reaction, either directly on or above the substrate 126.

A window assembly is positioned within the processing chamber 200 to hold a first window, such as a UV vacuum window 212. The window assembly includes a vacuum window clamp 210 that rests on a portion of the body 162 (FIG. 1) and supports a vacuum window 212 through which UV light may pass from the UV lamp bulbs 122. The vacuum window 212 is generally positioned between the UV radiation source, such as UV lamp bulbs 122, and the substrate support 124. A showerhead 214, which may be formed of various transparent materials such as quartz or sapphire, is positioned within the processing region 160 and between the vacuum window 212 and the substrate support 124. The transparent showerhead 214 forms a second window through which UV light may pass to reach the substrate 126. The transparent showerhead defines an upper processing region 220 between the vacuum window 212 and transparent showerhead 214 and further defines a lower processing region 222 between the transparent showerhead 214 and the substrate support, such as substrate support 124. The transparent showerhead 214 also has one or more passages 216 between the upper and lower processing regions 220, 222. The passages 216 may have a roughened internal surface for diffusing the UV light so there is no light pattern on the substrate 126 during processing. The size and density of the passages 216 may be uniform or non-uniform to effectuate the desired flow characteristics across the substrate surface. The passages 216 may have either a uniform flow profile where the flow per radial area across the substrate 126 is uniform or the gas flow can be preferential to the center or edge of the substrate 126, i.e. the gas flow may have a preferential flow profile.

The front and/or back surface of the transparent showerhead 214 and vacuum window 212 may be coated to have a band pass filter and to improve transmission of the desired wavelengths or improve irradiance profile of the substrate. For example, an anti-reflective coating (ARC) layer may be deposited on the transparent showerhead 214 and vacuum window 212 to improve the transmission efficiency of desired wavelengths. The ARC layer may be deposited in a way that the thickness of the reflective coating at the edge is relatively thicker than at the center region of the transparent showerhead 214 and vacuum window 212 in a radial direction, such that the periphery of the substrate disposed underneath the vacuum windows 212 and the transparent showerhead 214 receives higher UV irradiance than the center. The ARC coating may be a composite layer having one or more layers formed on the surfaces of the vacuum window 212 and transparent showerhead 214. The compositions and thickness of the reflective coating may be tailored based on the incidence angle of the UV radiation, wavelength, and/or the irradiance intensity. A more detailed description/benefits of the ARC layer is further described in the commonly assigned U.S. patent application Ser. No. 13/301,558 filed on Nov. 21, 2011 by Baluja et al., which is incorporated by reference in its entirety.

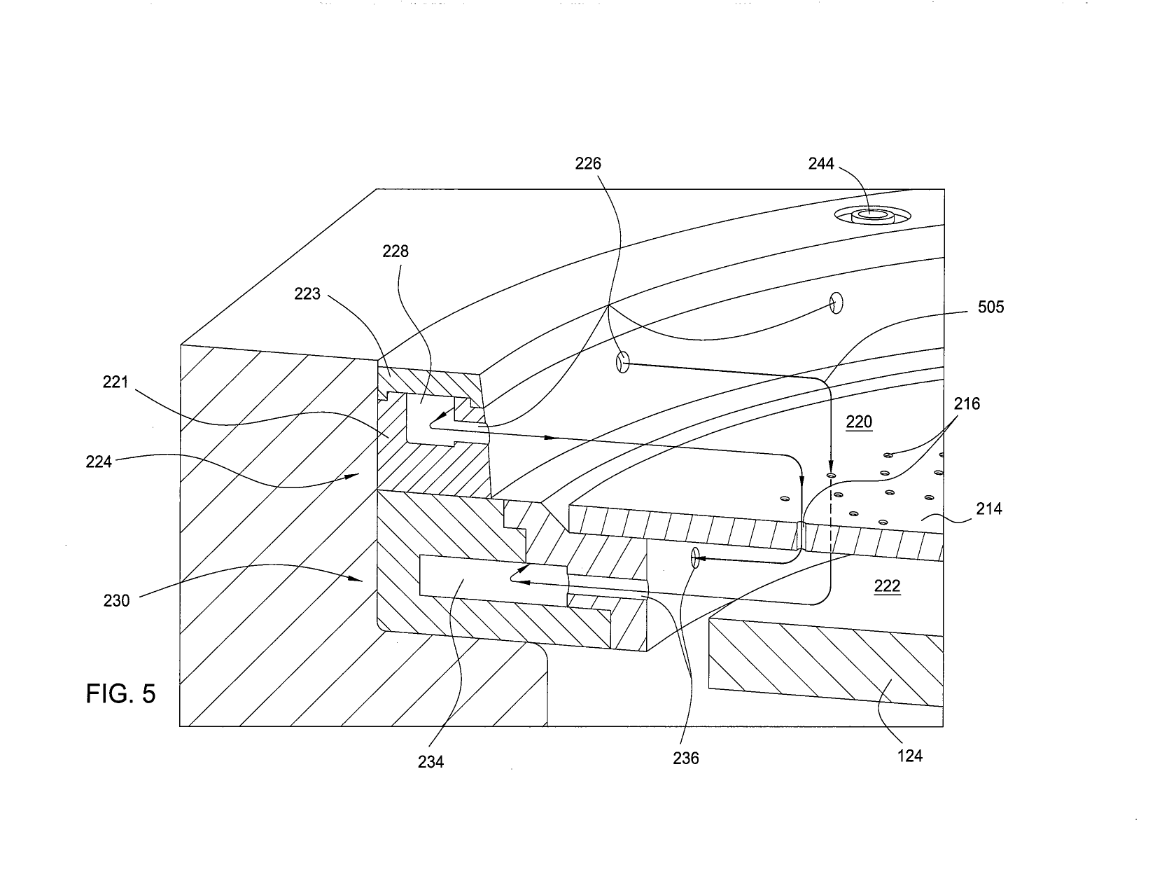

A gas distribution ring 224 made of aluminum oxide is positioned within the processing region 160 proximate to the sidewall of the UV chamber. The gas distribution ring 224 can be a single piece, or can include a gas inlet ring 223 and a base distribution ring 221 having one or more gas distribution ring passages 226. The gas distribution ring 224 is configured to generally surround the circumference of the vacuum window 212. The gas inlet ring 223 may be coupled with the base distribution ring 221 which together may define the gas distribution ring inner channel 228. A gas supply source 242 is coupled to one or more gas inlets 244 (FIG. 5) formed in the gas inlet ring 223 through which gas may enter the gas distribution ring inner channel 228. The one or more gas distribution ring passages 226 couple the gas distribution ring inner channel 228 with the upper processing region 220, forming a gas flow path between the inner channel 228 and the upper processing region 220 above the transparent showerhead 214. A gas outlet ring 230 is positioned below the gas distribution ring 224 and may be at least partially below the transparent showerhead 214 within the processing region 160. The gas outlet ring 230 is configured to surround the circumference of the transparent showerhead 214 and having one or more gas outlet passages 236 coupling a gas outlet ring inner channel 234 and the lower processing region 222, forming a gas flow path between the lower processing region 222 and the gas outlet inner channel 234. The one or more gas outlet passages 236 of the gas outlet ring 230 are disposed at least partially below the transparent showerhead 214.

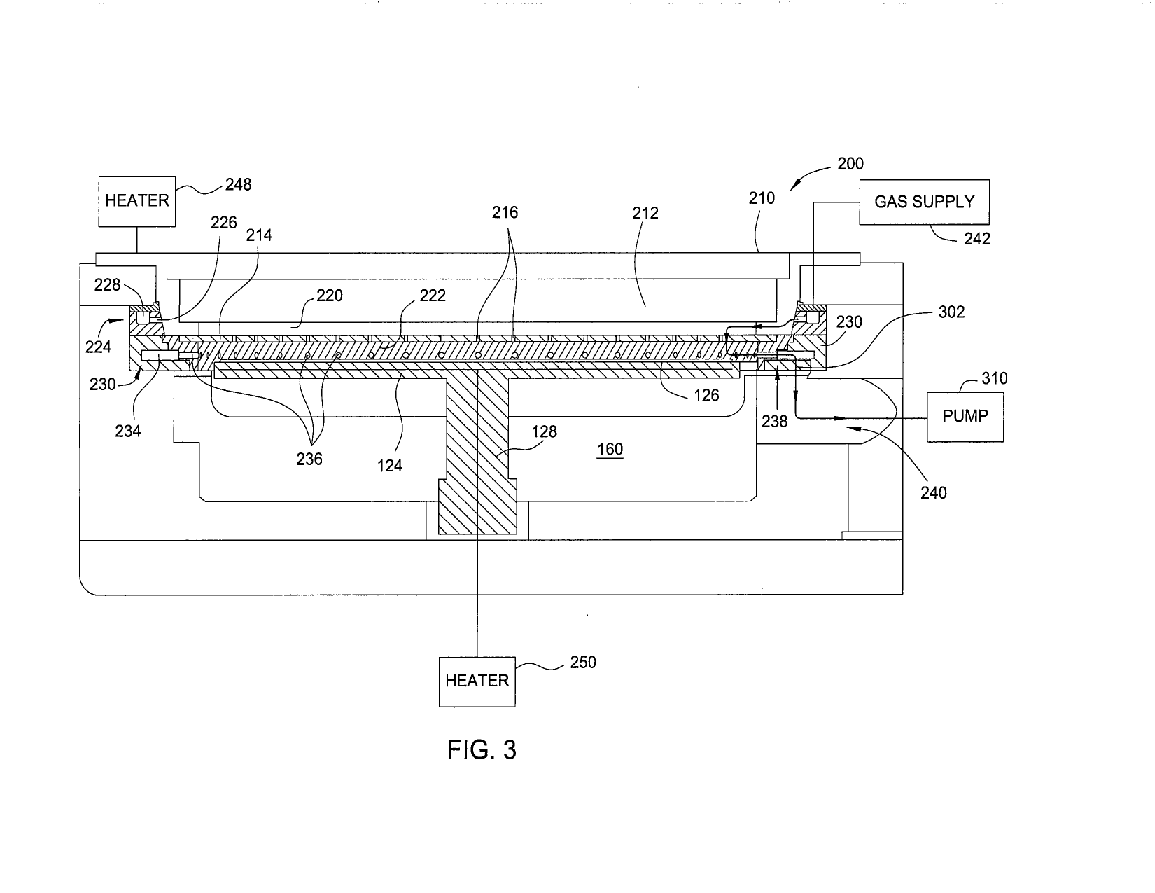

FIG. 3 depicts a schematic cross-sectional view of the processing chamber 200 in FIG. 2 illustrating a gas flow path. As indicated by arrow 302, carbon-based precursor, purge gas, or other types of gases may be injected into and evenly filled the upper processing region 220 between the vacuum window 212 and the transparent showerhead 214, through the transparent showerhead 214, over the substrate support 124 which may have a substrate 126 disposed thereon, down towards the substrate from the transparent showerhead 214. The gas flow washes over the substrate 126 from above, spreads out concentrically, and exits the lower processing region 222 through gas outlet passages 236. The gas then is ejected from the lower processing region 222, enters the gas outlet ring inner channel 234, and exits the gas outlet 238 into a gas exhaust port 240 and to a pump 310. Depending on the pattern of the passages 216 in the showerhead 214, the gas flow profile may be controlled across the substrate 126 to provide a desired uniform or non-uniform distribution. A more detailed description/benefits of the processing chamber 200 is further described in the commonly assigned U.S. patent application Ser. No. 13/248,656 filed on Sep. 29, 2011 by Baluja et al., which is incorporated by reference in its entirety.

### Exemplary Seasoning Process

As indicated above, while build-up of porogen or residues on the surfaces of the optical components, such as the vacuum window 212 and the transparent showerhead 214 shown in FIGS. 1-3, within the UV processing chamber may be removed by a plasma-cleaning process using a fluorine-based gas, the optical components suffer from the detrimental attack of fluorine radicals with time. To solve the issue, the present inventors have proposed various approaches to prevent fluorine radical attack and any build-up of porogen outgassed from the substrate during the chamber cleaning or processing of the substrate such as a UV curing process.

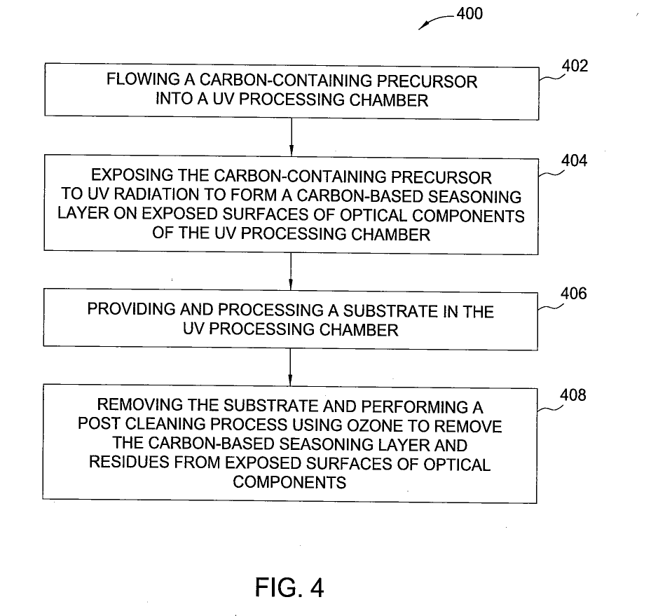

FIG. 4 illustrates an exemplary process sequence 400 for pre-treating exposed surfaces of the optical components within a UV processing chamber in accordance with one embodiment of the present invention. The process 400 begins at box 402 by flowing a carbon-containing precursor into a UV processing chamber, such as the processing chamber described above with respect to FIGS. 1-2. The carbon-containing precursor is injected into the processing chamber and filled the upper processing region 220 between the vacuum window 212 and the transparent showerhead 214, and then flowed through the transparent showerhead 214 to the lower processing region 222 in a manner as described above with respect to FIG. 3. An exemplary gas flow path is illustrated in FIG. 5, which is a close up isometric cross-sectional view of a portion of the processing chamber 200. As depicted by arrows 505, the carbon-containing precursor may enter the gas inlet 244, flow through the gas distribution ring inner channel 228 and out the gas distribution ring passages 226 of the base distribution ring 221 to fill the volume above the transparent showerhead 214, e.g. the upper processing region 220. The carbon-containing precursor then flows through the showerhead passages 216 and flows concentrically and radially across the substrate support 124 to the gas outlet ring inner channel 234 through the gas outlet passages 236. The carbon-containing precursor then is ejected from the inner channel 234 to the gas outlet 238 (FIG. 3) into the gas exhaust port 240 and finally to the pump 310.

In various embodiments, the carbon-containing precursor may take the form of a gas or of a vaporized liquid in different embodiments. In one embodiment, the carbon-containing precursor may comprise a hydrocarbon precursor. Examples of hydrocarbon precursor may include, but is not limited to alkanes such as methane, ethane, propane, butane and its isomer isobutane, pentane and its isomers isopentane and neopentane, hexane and its isomers 2-methylpentance, 3-methylpentane, 2,3-dimethylbutane, and 2,2-dimethyl butane, and so on; alkenes such as ethylene, propylene, butylene and its isomers, pentene and its isomers, and the like, dienes such as butadiene, isoprene, pentadiene, hexadiene and the like, and halogenated alkenes include monofluoroethylene, difluoroethylenes, trifluoroethylene, tetrafluoroethylene, monochloroethylene, dichloroethylenes, trichloroethylene, tetrachloroethylene, and the like; alkynes such as acetylene, propyne, butyne, vinylacetylene and derivatives thereof; aromatic such as benzene, styrene, toluene, xylene, ethylbenzene, acetophenone, methyl benzoate, phenyl acetate, phenol, cresol, furan, and the like, alpha-terpinene, cymene, 1,1,3,3,-tetramethylbutylbenzene, t-butylether, t-butylethylene, methyl-methacrylate, and t-butylfurfurylether, compounds having the formula C₃H₂ and C₅H₄, halogenated aromatic compounds including monofluorobenzene, difluorobenzenes, tetrafluorobenzenes, hexafluorobenzene and the like.

Suitable dilution gases such as helium (He), argon (Ar), hydrogen (H₂), nitrogen (N₂), ammonia (NH₃), or combinations thereof, among others, may be flowed with the carbon-containing precursor in certain embodiments.

At box 404, the carbon-containing precursor flowing within the processing chamber is exposed to UV radiation in a manner sufficient to break down the carbon-containing precursor in the upper and lower processing regions 220, 222, forming a carbon-based seasoning layer on the exposed surfaces of the chamber components. Particularly, any or all of the exposed surfaces of the optical components, such as the vacuum window 212 (not shown in FIG. 4) and the transparent showerhead 214, which are exposed to processing precursor or porogen outgassed from the substrate during the subsequent UV curing process are coated with the carbon-based seasoning layer. In an alternative embodiment, the optical components may be exposed to UV radiation prior to introduction of the carbon-containing precursor into the processing chamber. By doing so, the temperature of the chamber components (including optical components) is ready to break down the carbon-containing precursor when it hits to the optical components.

The carbon-based seasoning layer can be a hydrocarbon-based material layer in cases where the hydrocarbon precursor is used as the carbon-containing precursor. The term “hydrocarbon-based” material layer as used herein may refer to a polymer film derived from a hydrocarbon precursor material, a polymer film constituted substantially of hydrocarbon, an organic carbon polymer film, a nano-carbon polymer film, or simply a carbon polymer film.

In operation, the vacuum window 212 and the transparent showerhead 214 are heated due to the infrared light coming from the UV lamp bulbs 122 (FIG. 1). The chamber components such as the vacuum window 212 and the transparent showerhead 214 may be heated to a temperature of about 400° C. or above. Additional heater 248, 250 may be used to heat the components in the processing chamber such as the vacuum window clamp 210, the vacuum window 212, the gas distribution ring 224, and the substrate support 124. Heating these chamber components may improve the efficiency of the dissociation while reducing the condensation and/or deposition of porogen on the optical components. The IR light absorbed by the vacuum window 212 and the transparent showerhead 214 creates a temperature gradient which interacts with the carbon-containing precursor injected into the upper processing region 220 from the gas distribution ring 224, causing the carbon-containing precursor to break down into species and form a carbon-based seasoning layer on the exposed surfaces of the vacuum window 212 and the transparent showerhead 214. While forming the carbon-based seasoning layer on the exposed surfaces of the vacuum window 212 and the transparent showerhead 214 (e.g., the bottom surface of the vacuum window 212 and the upper surface of the transparent showerhead 214), the carbon-containing precursor traveling down into the lower processing region 222 also forms a carbon-based seasoning layer onto other exposed surfaces of the optical components, such as the bottom side of the transparent showerhead 214. The carbon-based seasoning layer may also form on exposed surfaces of the chamber components where the carbon-containing precursor flow through (i.e., the gas flow path).

After the carbon-based seasoning layer has been deposited on exposed surfaces of the optical components, the processing gas, for example a silicon-based precursor used in the subsequent process for forming the ultra low-k dielectric materials and porogen outgassed from the substrate during a UV curing process, can hardly be collected or deposited on the exposed surface of the optical components, such as the vacuum window 212 and the transparent showerhead 214. Therefore, UV efficiency is increased. In certain embodiments, the carbon-based seasoning layer also prevents the exposed surfaces of the optical components from fluorine radicals attack during the subsequent cleaning process (e.g., the post cleaning process described below at box 408).

At box 406, a substrate is provided into the processing chamber (i.e., processing chamber 200 of FIGS. 1-3) and a substrate process such as a UV curing process or any thermal process where energy in the form of light is used to process a substrate or catalyze a reaction is performed in the processing chamber.

At box 408, upon completion of the substrate process, the substrate is removed from the processing chamber and a post cleaning process may be performed to remove all carbon-based and silicon-based residues from the exposed surfaces of the optical components, such as the vacuum window 212 and the transparent showerhead 214. In one embodiment, the post cleaning process may be performed by flowing ozone (O₃) gas into the processing chamber in a manner as described above with respect to FIGS. 3 and 4. The post cleaning process may be performed with the optical components exposing to UV radiation to improve the efficiency of ozone degeneration. Production of the necessary ozone may be done remotely with the ozone transported to the processing chamber, generated in-situ by activating oxygen with UV light to create ozone, or accomplished by running these two schemes simultaneously. The UV radiation break down the ozone into molecular oxygen and reactive oxygen radicals, reacts with deposited residues formed during the UV curing process and/or oxidizes the carbon-based seasoning layer (e.g., the hydrocarbon-based material layer) formed on the exposed surfaces of the optical components to produce carbon dioxide and water as the resulting products. These resulting produces and decomposed residues are then pumped into the gas exhaust port 240 and to the pump 310.

To enhance clean efficiency, a fluorine-containing gas may be optionally introduced into the processing chamber before the post cleaning process. The fluorine-containing gas may be introduced into a remote plasma source (RPS) chamber (not shown). The radicals produced in the RPS chamber are then drawn into the processing chamber in a manner as described above with respect to FIGS. 3 and 4 to carry out a carbon-seasoning layer removal process, which cleans all of the exposed surfaces of the chamber components.

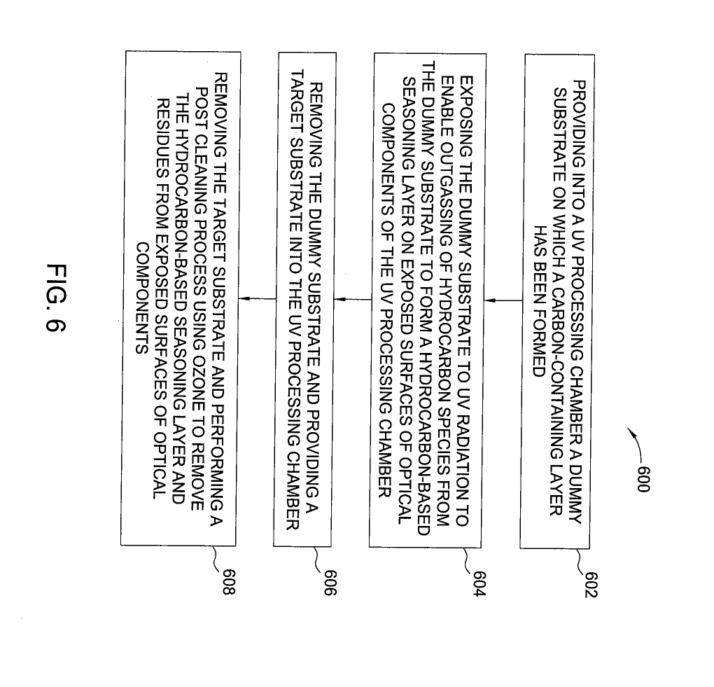

FIG. 6 illustrates an exemplary process sequence 600 for pre-treating exposed surfaces of the optical components within a UV processing chamber in accordance with another embodiment of the present invention. The process 600 begins at box 602 by providing into a processing chamber a dummy substrate on which a carbon-containing layer has been formed. The carbon-containing layer may be a hydrocarbon-based compound formed by using the hydrocarbon precursor as discussed above with respect to box 402.

At box 604, the substrate is exposed to UV radiation to enable outgassing of hydrocarbon species from the dummy substrate. The hydrocarbon species accumulates on the exposed surfaces of the optical components, such as the vacuum window 212 and the transparent showerhead 214 of the processing chamber 200, thereby forming a hydrocarbon-based seasoning layer onto the exposed surfaces of the optical components. The hydrocarbon-based seasoning layer serves as a barrier layer so that any silicon-based residues or SiO particles produced during the substrate processing can hardly be collected or deposited on the exposed surfaces of the optical components, such as the vacuum window 212 and the transparent showerhead 214. Therefore, UV efficiency is increased.

At box 606, after the hydrocarbon-based seasoning layer has been deposited on the exposed surfaces of the optical components, the dummy substrate is removed and a target substrate is loaded into the processing chamber (i.e., processing chamber 200 of FIGS. 1-3). The target substrate is then subjected to a substrate process such as a UV curing process or any thermal process as discussed above with respect to box 406.

At box 608, upon completion of the substrate process, the target substrate is removed from the processing chamber and a post cleaning process may be performed to remove all carbon-based and silicon-based residues or unwanted particles from the exposed surfaces of the optical components. The post cleaning process may be similar to one discussed above in box 408.

Embodiments of the invention improve the temperature uniformity of the substrate by 2-3 times and the vacuum window is more effectively cleaned. The application of the carbon-based seasoning layer and the post cleaning process together with an optimized flow pattern effectively clean the optical components in the UV processing chamber, such as the UV vacuum window and transparent showerhead, without risk of etching by fluorine radicals. The throughput of this system is increased because it allows for higher efficiency of both cleaning and curing processes. It has been observed that the wet cleaning interval was increased from about every 200 substrates to about every 2,000 substrates. Keeping the optical components cleaner to reduce different light intensities across the window surface caused by build-up of deposited residues.

While the foregoing is directed to embodiments of the invention, other and further embodiments of the invention may be devised without departing from the basic scope thereof.

1. A method for treating a thermal processing chamber, comprising:
flowing a carbon-containing precursor into the thermal processing chamber, comprising:
introducing the carbon-containing precursor into an upper processing region of the thermal processing chamber, the upper processing region located between a window and a transparent showerhead positioned within the thermal processing chamber; and
flowing the carbon-containing precursor through one or more passages formed in the transparent showerhead and into a lower processing region, the lower processing region located between the transparent showerhead and a substrate support located within the thermal processing chamber;
exposing the carbon-containing precursor to a thermal radiation to form a carbon-based seasoning layer on exposed surfaces of the window and the transparent showerhead within the thermal processing chamber; and
exposing the carbon-based seasoning layer to ozone to remove the carbon-based seasoning layer from exposed surfaces of the window and the transparent showerhead.

2. The method of claim 1, wherein the introducing a carbon-containing precursor into the upper processing region further comprises:
flowing the carbon-containing precursor radially from a gas distribution ring configured to surround a circumference of the window to one or more passages formed in the transparent showerhead.

3. The method of claim 2, wherein the flowing a carbon-containing precursor into the thermal processing chamber further comprises:
ejecting the carbon-containing precursor radially from the lower processing region into a gas outlet ring configured to surround a circumference of the transparent showerhead.

4. The method of claim 1, wherein the carbon-containing precursor comprises a hydrocarbon precursor and the carbon-based seasoning layer comprises a hydrocarbon-based material.

5. The method of claim 1, wherein the thermal radiation comprises ultraviolet (UV) or infrared (IR) radiation.

6. The method of claim 1, wherein the exposing a carbon-based seasoning layer to ozone further comprises:
heating the window and the transparent showerhead to a temperature of about 400° C. or above.

7. The method of claim 1, wherein the exposing the carbon-based seasoning layer to ozone further comprises:
flowing the ozone radially from a gas distribution ring configured to surround a circumference of the window into an upper processing region and to one or more passages formed in the transparent showerhead; and
ejecting the ozone radially from the lower processing region into a gas outlet ring configured to surround a circumference of the transparent showerhead.

8. The method of claim 1, further comprising:
exposing the exposed surfaces of the window and the transparent showerhead to fluorine-containing radicals introduced from a remote plasma source.

9. A method for treating a thermal processing chamber, comprising:
providing a dummy substrate into the thermal processing chamber, the dummy substrate having a carbon-containing layer formed thereon;
exposing the carbon-containing layer to a thermal radiation to outgass carbon-based species which form a desired thickness of a carbon-based seasoning layer on exposed surfaces of exposed surfaces of optical components within the thermal processing chamber;
removing the dummy substrate; and
exposing the carbon-based seasoning layer to ozone to remove the carbon-based seasoning layer from exposed surfaces of the optical components.

10. The method of claim 9, wherein the carbon-containing layer comprises a hydrocarbon-based compound.

11. The method of claim 9, wherein the thermal radiation comprises ultraviolet (UV) or infrared (IR) radiation.

12. The method of claim 9, wherein the carbon-based seasoning layer comprises a hydrocarbon-based material.

13. The method of claim 9, wherein the exposing a carbon-based seasoning layer to ozone further comprises:
flowing a carbon-containing precursor into the thermal processing chamber, comprising:
introducing the ozone into an upper processing region of the thermal processing chamber, the upper processing region located between a window and a transparent showerhead positioned within the thermal processing chamber; and
flowing the ozone through one or more passages formed in the transparent showerhead and into a lower processing region, the lower processing region located between the transparent showerhead and a substrate support located within the thermal processing chamber.

14. The method of claim 13, wherein the introducing ozone into the upper processing region further comprises:
flowing the ozone radially from a gas distribution ring configured to surround a circumference of the window to the one or more passages formed in the transparent showerhead.

15. The method of claim 13, further comprising:
ejecting the ozone radially from the lower processing region into a gas outlet ring configured to surround a circumference of the transparent showerhead,

16. The method of claim 13, wherein the exposing the carbon-based seasoning layer to ozone further comprises:
heating the window and the transparent showerhead to a temperature of about 400° C. or above.

17. A method for treating a thermal processing chamber, comprising:
flowing a carbon-containing precursor radially inwardly across exposed surfaces of one or more optical components within the thermal processing chamber from a circumference of the one or more optical components;
exposing the carbon-containing precursor to a thermal radiation emitted from a heating source to form a carbon-based seasoning layer on the exposed surfaces of the one or more optical components;
exposing the carbon-based seasoning layer to ozone, wherein the ozone is introduced into the processing chamber by flowing the ozone radially inwardly across exposed surfaces of one or more optical components from the circumference of the one or more optical components; and
heating the one or more optical components to a temperature of about 400° C. or above while flowing the ozone to remove the carbon-based seasoning layer from exposed surfaces of the one or more optical components.

18. The method of claim 17, wherein the carbon-containing precursor comprises a hydrocarbon precursor and the carbon-based seasoning layer comprises a hydrocarbon-based material.

19. The method of claim 17, wherein the thermal radiation comprises ultraviolet (UV) or infrared (IR) radiation.

20. The method of claim 17, wherein the one or more optical components comprise a transparent window and a transparent showerhead disposed in parallel to one another and located between the heating source and a substrate support.
